(19) United States
(12) Patent Application Publication
(10) Pub. No.: US 2025/0162106 A1
(43) Pub. Date: May 22, 2025

(54) ADJUSTABLE INSTRUMENT REPAIR BRACKET AND METHOD OF USE

(71) Applicant: Xiaohui YE, Ningbo (CN)

(72) Inventor: Xiaohui YE, Ningbo (CN)

(21) Appl. No.: 18/515,324

(22) Filed: Nov. 21, 2023

(51) Int. Cl. B25B 5/02

(52) U.S. Cl. CPC B25B 5/02

(57) ABSTRACT

The present invention relates to an adjustable instrument repair bracket and method of use. The instrument repair bracket comprises at least one supporting component and a base component which is arranged below the supporting component in a sliding way, wherein the supporting component comprises a supporting frame and a bracket base, wherein a storage slot is arranged in the middle of the supporting frame, and the supporting frame is provided with an adjusting device, and the adjusting device can adjust the accommodating width of the storage slot and the height of the storage slot relative to the ground; the method of use comprises respectively adjusting the accommodating width of the storage slot, respectively adjusting the height of the storage slot relative to the ground, and adjusting the relative distance between at least two supporting components.

### TECHNICAL FIELD

The present invention relates to the technical field of maintenance instrument, in particular to an adjustable instrument repair bracket and method of use.

### BACKGROUND

During maintenance, guns such as rifles, pistols and crossbows are usually held by clamps, brackets or other mechanical support devices, or supported in other ways. This can free the hands of the armorer to perform maintenance tasks, and can apply torque to the gun parts. However, at present, most gun body brackets on the market cannot support rifles, pistols, crossbows and other objects at the same time, and the brackets have low adaptability and large volume, so it is difficult to accommodate them.

U.S. Patent. No. 20210114174 discloses a tool system for assembling and repairing firearms, which is an armored tool system for distributing applied torque on a very wide surface, mainly related to assembling and disassembling the barrel and lower receiver extension of firearms, independent of the specifications of the external features of the barrel extension, lower receiver and upper receiver. However, this kind of bracket is of a fixed size and shape, and it is impossible to adapt to various types of gun instrument by adjusting the distance of the gun bracket, which has great limitations in use.

US20200370853 discloses a gun vice and a supporting device, which comprises a gun vice and a gun supporting device. When it is necessary to maintain or assemble a gun, the gun supporting device and the gun vice can be used together to firmly position the gun in a proper position. However, this kind of support device is bulky, and it is difficult to store it when it is not used or transported.

Based on the above problems, it is necessary to provide a brand-new instrument repair bracket, which can be adapted to different gun instrument by adjusting the up-and-down height and the distance from front to back. At the same time, the bracket can be disassembled into two parts to reduce the volume and facilitate storage and transportation.

### SUMMARY

The present invention provides an instrument repair bracket, which includes at least one supporting component and a base component,
the supporting component comprises a bracket base and a supporting frame detachably attached to said bracket base, wherein said supporting frame comprises at least one clamping piece, and said clamping piece is connected with a transverse adjusting mechanism in a transmission way, and said clamping piece defines a storage slot with an adjustable transverse width through the transverse adjusting mechanism, wherein said supporting frame is also provided with a longitudinal adjusting mechanism, and said longitudinal adjusting mechanism supports said storage slot, so that said storage slot has an altitude high position and an altitude low position;
the base component is provided with a track device, and said supporting component is provided with a slot device complementary to the track device; and said supporting component is slidably arranged above said base component through said track device and said slot device.

The present invention also provides an instrument repair bracket, which comprises at least two supporting components and a base component,
the supporting component comprises a bracket base and a supporting frame detachably attached to the bracket base, wherein the supporting frame comprises at least one clamping piece, and the clamping piece is connected with a transverse adjusting mechanism in a transmission way, and the clamping piece defines a storage slot with an adjustable transverse width through the transverse adjusting mechanism, wherein the supporting frame is also provided with a longitudinal adjusting mechanism, and the longitudinal adjusting mechanism supports the storage slot, so that the storage slot has an altitude high position and an altitude low position;
the base component is provided with a track device, the supporting component is provided with a slot device complementary to the track device, and the supporting component is arranged above the base component through the track device and the slot device;
wherein, when the two supporting components slide above the base component, there is an adjustable distance between the two supporting components.

The present invention also provides a method of use of the instrument repair bracket, which comprises the following steps: providing an instrument repair bracket;
the instrument repair bracket comprises at least two supporting components and a base component slidably arranged below the supporting components, wherein the supporting component comprises a supporting frame and a bracket base, wherein a middle part of the supporting frame is provided with a storage slot, and the supporting frame is provided with an adjusting device, and the adjusting device can adjust an accommodating width of the storage slot and a height of the storage slot relative to the ground;
the method of use comprises the following steps:
respectively adjusting the accommodating width of the storage slot;
respectively adjusting the height of the storage slot relative to the ground;
adjusting a relative distance between at least two supporting components.

The terms “invention,” “the invention,” “this invention” and “the present invention” used in this patent are intended to refer broadly to all of the subject matter of this patent and the patent claims below: Statements containing these terms should be understood not to limit the subject matter described herein or to limit the meaning or scope of the patent claims below. Embodiments of the invention covered by this patent are defined by the claims below, not this summary. This summary is a high-level overview of various embodiments of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings and each claim.

### BRIEF DESCRIPTION OF DRAWINGS

In order to explain the technical scheme of this application more clearly, the drawings needed in the implementation will be briefly introduced below. Obviously, the drawings described below are only some implementations of this application. For those skilled in the art, other drawings can be obtained according to these drawings without creative work.

FIG. 1 is a schematic diagram of an instrument repair bracket in the application of the present invention;

FIG. 2 is a schematic diagram of an instrument repair bracket in the application of the present invention;

FIG. 3 is a schematic diagram of an instrument repair bracket in the application of the present invention;

FIG. 4 is a schematic diagram of an instrument repair bracket in the application of the present invention;

FIG. 5 is a schematic diagram of parts in the application of the present invention;

FIG. 6 is a schematic diagram of parts in the application of the present invention;

FIG. 7 is a schematic diagram of parts in the application of the present invention;

FIG. 8 is a schematic view of the supporting component in the application of the present invention;

FIG. 9 is a sectional view of the supporting component in the application of the present invention;

FIG. 10 is a schematic diagram of a supporting frame in the application of the present invention;

FIG. 11 is a schematic diagram of a bracket base in the application of the present invention;

FIG. 12 is a schematic diagram of a shelf in the application of the present invention;

FIG. 13 is a schematic diagram of the base component in the application of the present invention;

FIG. 14 is a schematic diagram of a supporting base in the application of the present invention;

FIG. 15 is a schematic view of a supporting foot in the application of the present invention.

FIG. 16 is a schematic diagram of a component of another embodiment in the application of the present invention;

In the figures:
1000, Instrument repair bracket; 2000, Supporting component; 2100, Supporting frame; 2110, Transverse adjusting mechanism; 2120, Clamping piece; 2130, Longitudinal adjusting mechanism; 2140, Storage slot; 2200, Bracket base; 2210, Adjusting member; 2220, Adjusting plate; 2230, Assembling button; 2300, Shelf; 3000, Base component; 3100, Supporting base; 3110, Conduit; 3200, Supporting leg; 3210, Adjuster; 3220, Circular tube; 3221, Limiting part; 3222, Through hole; 3223, Dismounting device; 3300, Straightening part; 4000, Notch; 4100, Track device.

### DESCRIPTION OF EMBODIMENTS

In describing the preferred embodiments, specific termi-nology will be resorted to for the sake of clarity. It is to be understood that each specific term includes all technical equivalents which operate in a similar manner to accomplish a similar purpose.

While various aspects and features of certain embodiments have been summarized above, the following detailed description illustrates a few exemplary embodiments in further detail to enable one skilled in the art to practice such embodiments. Reference will now be made in detail to embodiments of the inventive concept, examples of which are illustrated in the accompanying drawings. The accompanying drawings are not necessarily drawn to scale. The described examples are provided for illustrative purposes and are not intended to limit the scope of the invention. It should be understood, however, that persons having ordinary skill in the art may practice the inventive concept without these specific details.

It will be understood that, although the terms first, second, etc. may be used herein to describe various elements, these elements should not be limited by these terms. These terms are only used to distinguish one element from another. For example, a first attachment could be termed a second attachment, and, similarly, a second attachment could be termed a first attachment, without departing from the scope of the inventive concept.

It will be understood that when an element or layer is referred to as being “on,” “coupled to,” or “connected to” another element or layer, it can be directly on, directly coupled to or directly connected to the other element or layer, or intervening elements or layers may be present. In contrast, when an element is referred to as being “directly on,” “directly coupled to,” or “directly connected to” another element or layer, there are no intervening elements or layers present. Like numbers refer to like elements throughout. As used herein, the term “and/or” includes any and all combinations of one or more of the associated listed items.

As used in the description of the inventive concept and the appended claims, the singular forms “a,” “an,” and “the” are intended to include the plural forms as well, unless the context clearly indicates other.

As a preferred embodiment of the present invention, in order to provide a bracket convenient for transportation and flexible use, the present application provides an instrument repair bracket 1000.

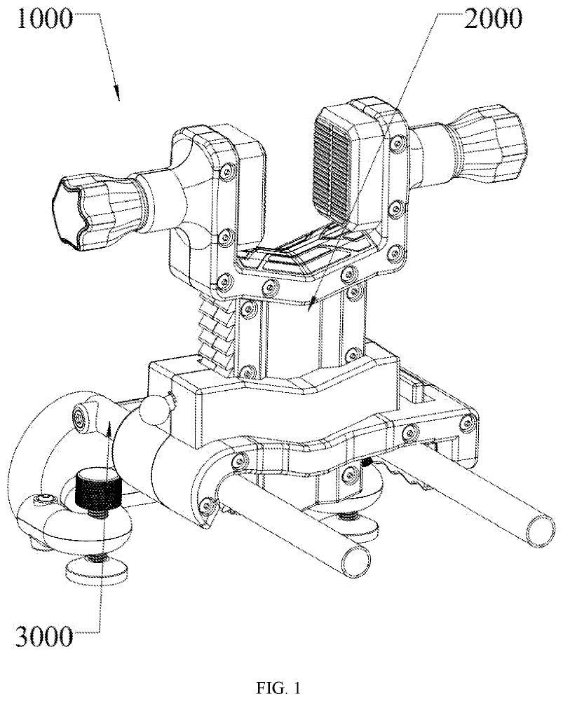

Referring to FIG. 1, in a preferred embodiment, an instrument repair bracket 1000 includes a supporting component 2000 and a base component 3000.

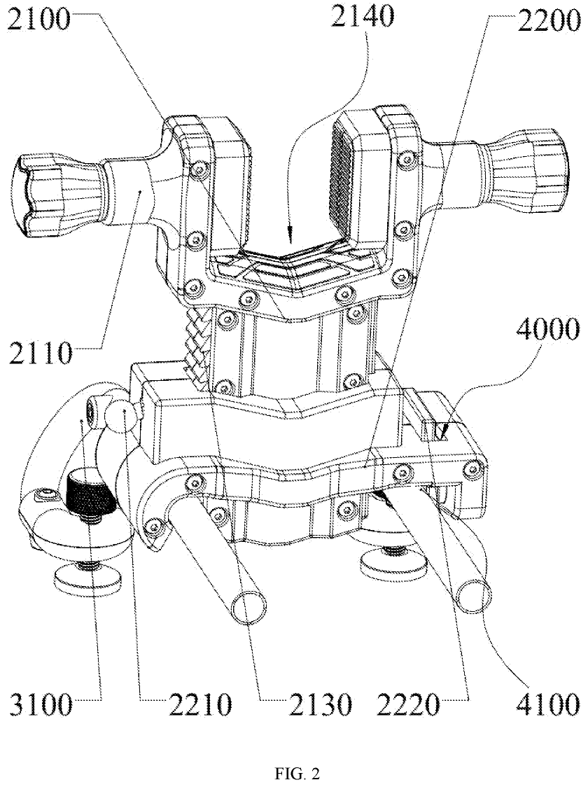

Referring to FIGS. 1 and 2, in this embodiment, the supporting component 2000 includes a supporting frame 2100 and a supporting base 2200.

The supporting frame 2100 is provided with at least one clamping piece 2120, and the clamping piece 2120 is attached to the inner side wall of the supporting frame 2100. In other embodiments, the number of clamping pieces 2120 may be one or more quantitative characteristics. The clamping piece 2120 forms a storage slot 2140, and the storage slot 2140 is controlled by the transverse adjusting mechanism 2110, and the storage slot 2140 can be controlled to adjust the transverse width. The supporting frame 2100 also includes a longitudinal adjusting mechanism 2130, which is located below the storage slot 2140 to support the storage slot 2140, so that the storage slot 2140 can rise and fall vertically.

The base component 3000 is provided with a track device 4100, and the supporting frame 2100 is provided with a notch 4000, which is complementary to the track device 4100 and cooperates with each other. The track device 4100 is located below the notch 4000.

In this embodiment, an adjusting plate 2220 is arranged in the notch 4000, and the supporting component 2000 slides on the base component 3000 through the adjusting plate 2220. The track device 4100 is composed of two conduits 3110, in this embodiment, there are two conduits 3110. The lower end of the conduit 3110 is connected with a support foot 3200, which is used to support the instrument repair bracket 1000.

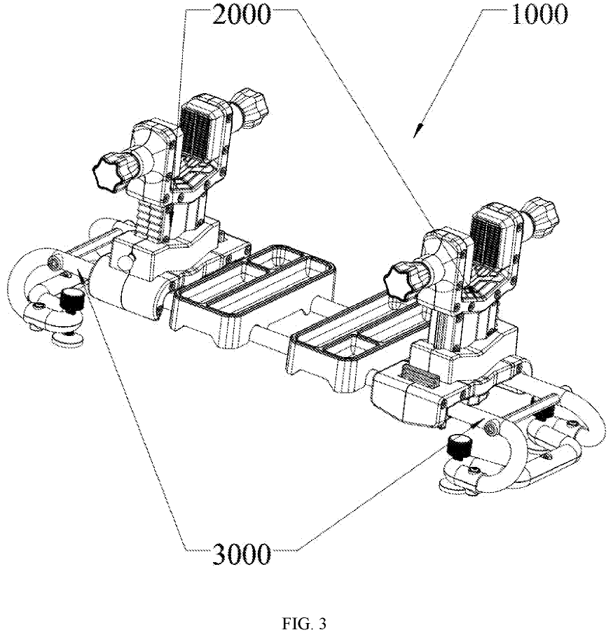

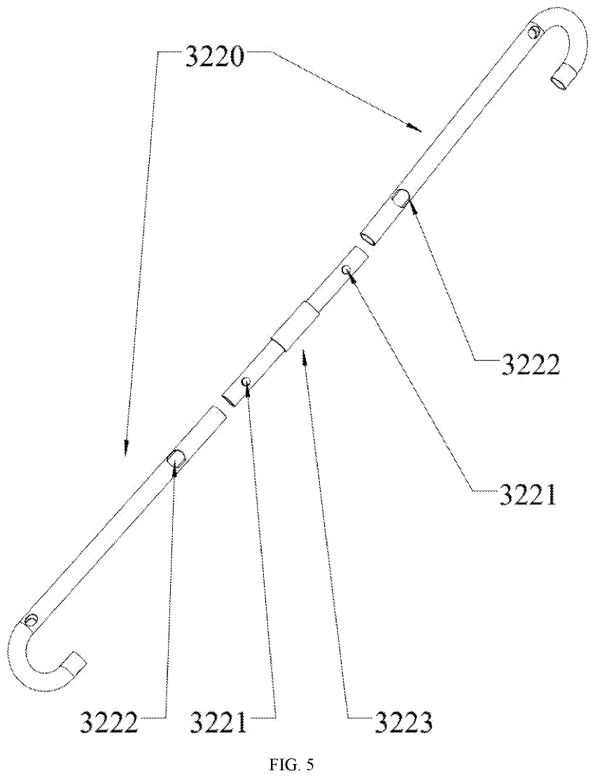

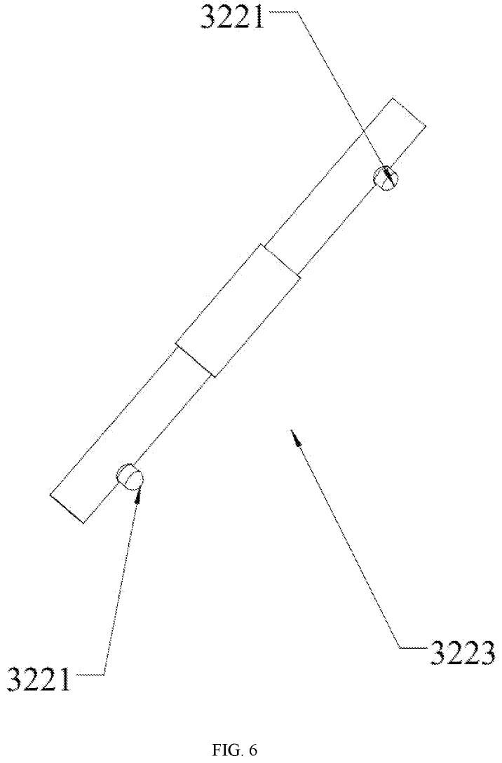

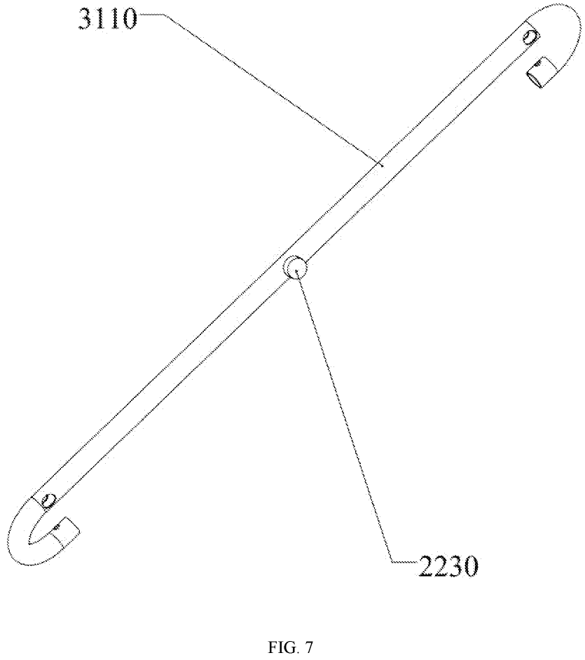

Specifically, referring to FIGS. 3 to 7, when the distance needs to be adjusted by the longitudinal adjusting mechanism 2130, the supporting frame 2100 can be lifted upward. When the supporting frame 2100 needs to be adjusted and lowered, the adjusting member 2210 needs to be pulled out first, and then the supporting frame 2100 needs to be adjusted so that the supporting frame 2100 can be lowered. Meanwhile, the supporting base 3100 is composed of two conduits 3110. Each conduit 3110 is composed of two circular tubes 3220, wherein each circular tube 3220 is provided with a through hole 3222. In other embodiments, the conduit 3110 and the circular tube 3220 may have other quantitative characteristics. A dismounting device 3223 is arranged between the circular tube 3220 and the circular tube 3220, and the dismounting device 3223 is installed inside the conduit 3110. The dismounting device 3223 is provided with a limiting part 3221 corresponding to the through hole 3222, and the limiting part 3221 is fixed in the through hole 3222 to form a limiting structure. In this embodiment, the limiting structure is similar to the snap structure. The limiting part 3221 and the through hole 3222 can be connected or detached by pressing, so that two circular tubes 3220 are fixedly connected to form a conduit 3110. A assembling button 2230 is provided on the outside of the conduit 3110. The assembling button 2230 is used to control the limiting part 3221 to enter and exit the through hole 3222. By pressing the assembling button 2230, the conduit 3110 can be disassembled into two circular tubes 3220, so that the whole supporting base 3100 can be formed into two parts, and the detachable function of the instrument repair bracket 1000 can be realized, which is convenient for transportation and storage of the instrument repair bracket 1000.

Referring to FIG. 3, in a preferred embodiment, the instrument repair bracket 1000 includes a supporting component 2000 and a base component 3000.

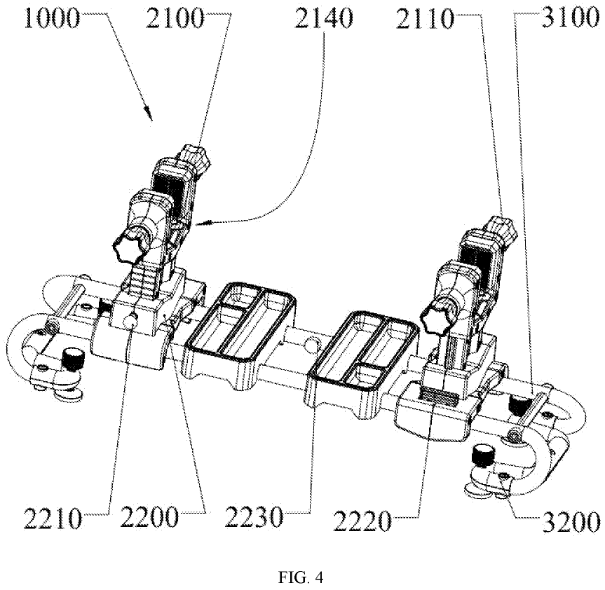

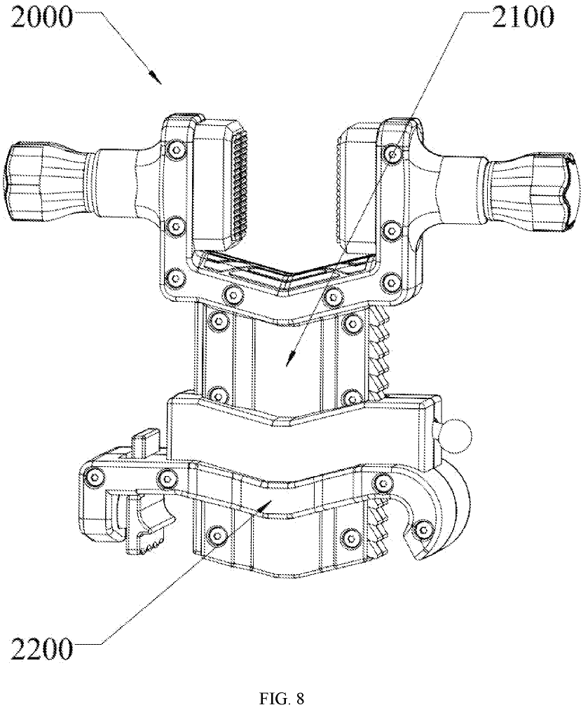

Referring to FIGS. 4 and 8, the supporting component 2000 includes at least two supporting frames 2100 and at least two supporting bases 2200.

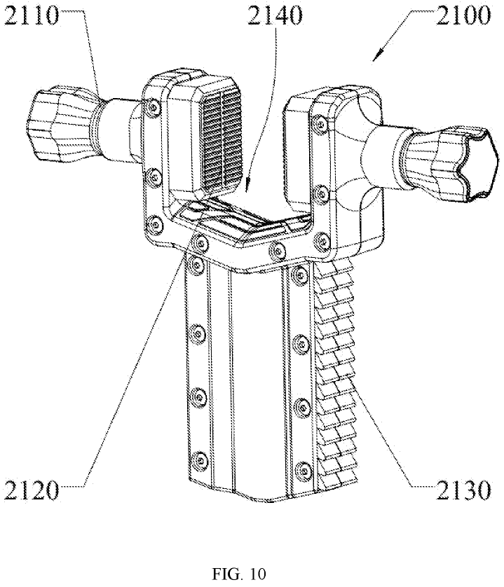

In this embodiment, as shown in FIGS. 4 and 10, there is a storage slot 2140 in the middle of the supporting frame 2100. The storage slot 2140 is used for placing articles that need to be repaired and supported. Clamping structures are arranged at both ends of the storage slot 2140. The clamping structures are composed of two clamping pieces 2120, and the clamping pieces 2120 are attached to the inner side wall of the supporting frame 2100. In other embodiments, the number of clamping pieces 2120 may be one or more quantitative characteristics.

Further, the surface of the clamping piece 2120 is provided with a plurality of anti-skid lines, which can increase the friction with the repaired object and prevent sliding.

In this embodiment, both sides of the supporting frame 2100 are also provided with transverse adjusting mechanisms 2110, which are knob structures, and adjust the accommodating width of the storage slot 2140 in the horizontal direction by rotating.

In other embodiments (not shown in the figure), the control mode may include physical buttons, such as rocker, dial, slide switch and joystick, click wheel, etc. In some alternative embodiments, the control device may be coupled to (or decoupled from) any of the following: a keyboard, an infrared port, a USB port and a pointing device, such as a mouse. In some embodiments (not shown in the figure), the control device can also be an electronic device, such as a touch screen, a computer device and other control system devices.

Further, one side of the supporting frame 2100 is provided with a longitudinal adjusting mechanism 2130, which is used to move the supporting frame 2100 in the vertical direction, and the longitudinal adjusting mechanism 2130 has a stepped shape. In other embodiments (not shown in the figure), the longitudinal adjusting mechanism 2130 can also be an arc structure, a square structure, or any other three-dimensional geometric shape, curved and irregular shape such as a triangular structure.

In this embodiment, the outer surface of the supporting frame 2100 is formed by connecting and fixing two shells, and the surfaces of the shells have a plurality of threaded holes, so that the shells can be detachably connected through bolt connection.

It should be further explained that the connection modes between housings are not limited to those listed above, and those skilled in the art can flexibly adjust and set the connection modes in practical applications, such as hook and loop connection mode, gluing connection mode, zipper connection mode, snap connection mode, snap connection mode and other connection fixing modes. As long as the shell can be connected and fixed to form the supporting frame 2100.

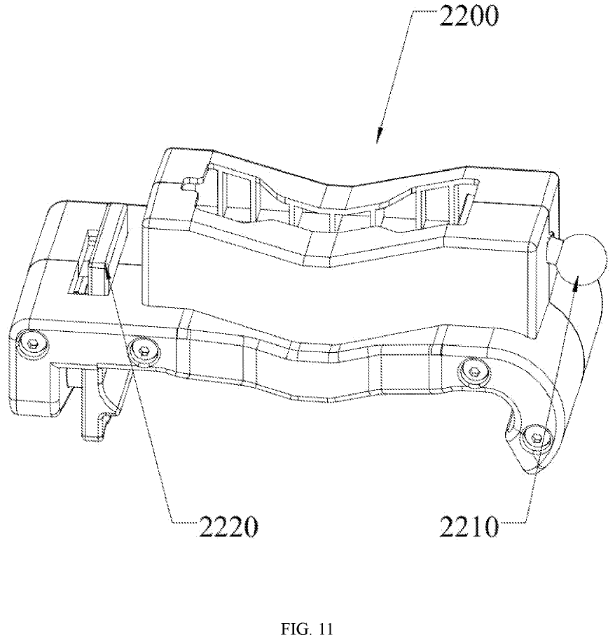

Referring to FIGS. 4 and 11, the bracket base 2200 has a roughly rectangular structure. In some embodiments, the structure of the bracket base 2200 can be circular, triangular, square or other geometric structures.

Further, the middle part of the bracket base 2200 has a hollow structure, and one side of the bracket base 2200 is provided with an adjusting member 2210, and the adjusting member 2210 is clamped on the longitudinal adjusting mechanism 2130 of the bracket 1000, so that the bracket 1000 can move in the vertical direction.

Further, the other side of the bracket base 2200 is provided with an adjusting plate 2220, and the adjusting plate 2220 is hung on the bracket base 2200 through two supporting structures. One side of the adjusting plate 2220 is in close contact with the inner side wall of the bracket base 2200, and the other side is connected with a elastic component. In this embodiment, there are two elastic component springs. In some embodiments (not shown in the figure), the elastic component may have other structures and the quantity may be one or more quantitative characteristics.

In this embodiment, the outer surface of the bracket base 2200 is formed by connecting and fixing two shells, and the surfaces of the shells are provided with a plurality of threaded holes, so that the shells can be detachably connected through bolt connection.

It should be further explained that the connection modes between housings are not limited to those listed above, and those skilled in the art can flexibly adjust and set the connection modes in practical applications, such as hook and loop connection mode, gluing connection mode, zipper connection mode, snap connection mode, snap connection mode and other connection fixing modes. As long as the housing can be connected and fixed to form the bracket base 2200.

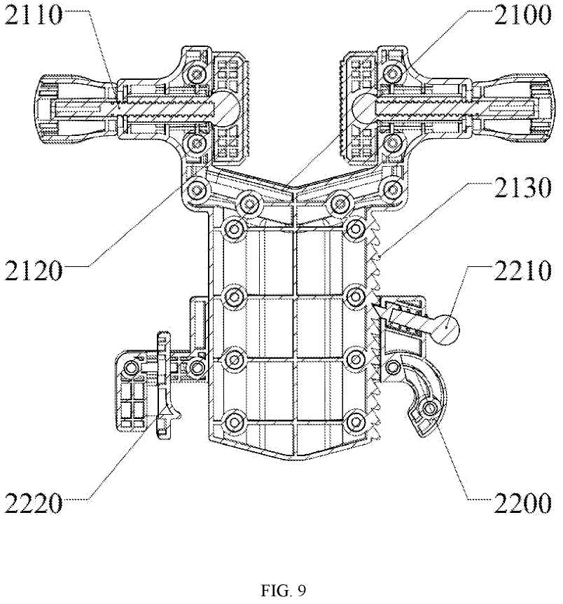

Specifically, as shown in FIGS. 8 and 9, when the supporting frame 2100 and the supporting base 2200 are assembled and connected, the supporting frame 2100 is inserted into the hollow structure of the supporting base 2200, and the longitudinal adjusting mechanism 2130 and the adjusting member 2210 of the supporting frame 2100 are mutually limited and fixed in a clamping manner, so that the supporting frame 2100 is fixed in the supporting base 2200.

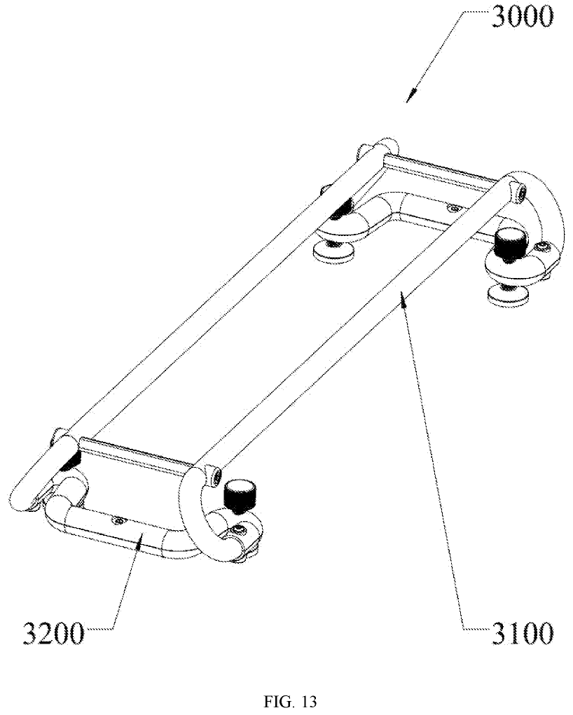

Referring to FIGS. 4 and 13, the base component 3000 is composed of a supporting base 3100 and a plurality of supporting legs 3200.

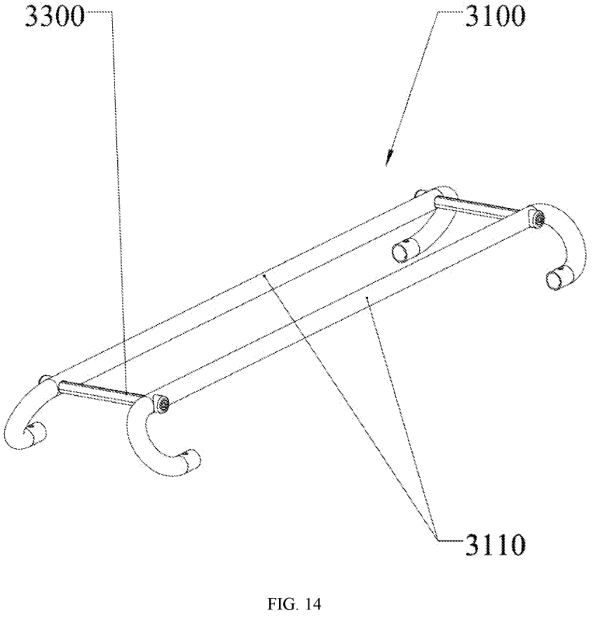

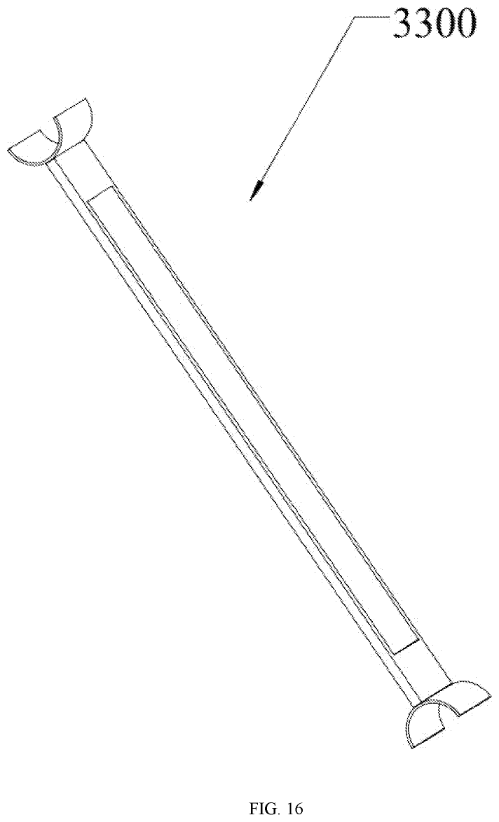

Referring to FIG. 14, in this embodiment, the supporting base 3100 is composed of two conduits 3110, and both ends of the conduits 3110 have outwardly bent extension parts. Further, two straightening pieces 3300 are connected in the middle of the conduit 3110, and the straightening pieces 3300 are used to keep the two conduits 3110 in a parallel state. The straightening piece 3300 is fixed on the supporting base 3100 through bolt connection. In other embodiments (as shown in FIG. 16), the connection mode can be hook and loop connection mode, gluing connection mode, zipper connection mode, snap connection mode or other connection and fixing modes.

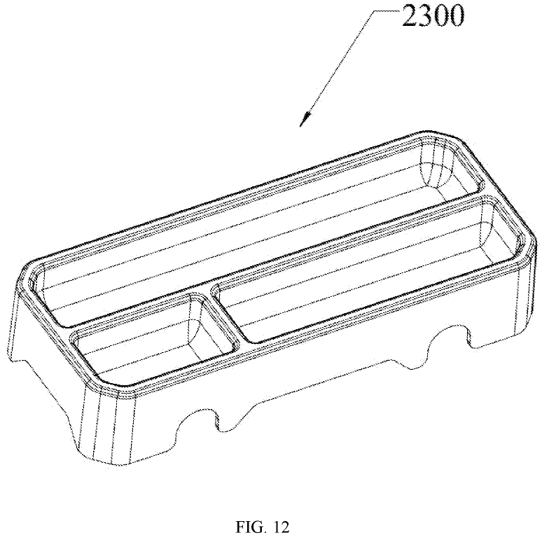

In this embodiment, as shown in FIGS. 4 and 12, the supporting base 3100 is further provided with a shelf 2300, which has a roughly rectangular structure and is used for placing disassembled parts of gun instrument to prevent the parts from being lost. The shelf 2300 has a ring-shaped buckle structure, and the shelf 2300 is connected with the supporting base 3100 by a buckle connection. The shelf 2300 can slide on the supporting base 3100.

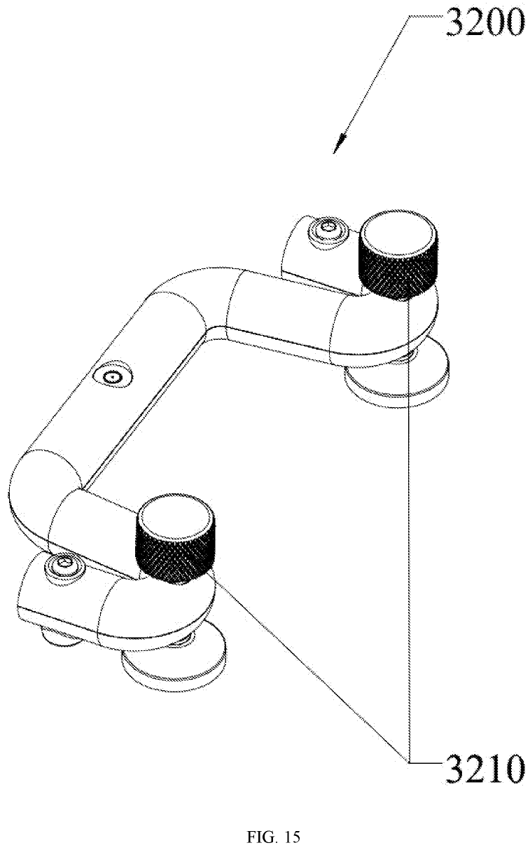

Referring to FIG. 13 and FIG. 15, the supporting legs 3200 have a zigzag structure. In this embodiment, four supporting legs 3200 are provided with adjusters 3210, which are used to adjust the vertical height of the instrument repair bracket 1000, and the supporting legs 3200 are connected with the supporting base 3100 through threads.

Referring to FIGS. 3 and 4, specifically, when the instrument repair bracket 1000 is assembled, the bottom of the bracket base 2200 has a curved hook structure, and the bracket base 2200 is hooked above the supporting base 3100. The upper part of the adjusting plate 2220 is in contact with the bracket base 2200, and the lower part is in contact with one of the conduits 3110 of the bracket base 2200. The adjusting plate 2220 enables the bracket base 2200 to slide on the supporting base 3100.

The supporting frame 2100 is inserted into the supporting base 2200, and a part of the supporting frame 2100 extends downward beyond a part of the supporting base 3100. The shelf 2300 can be movably placed in the middle of the supporting component 2000.

In this embodiment, referring to FIGS. 3 to 7, the instrument repair bracket 1000 has a symmetrical structure, which is composed of two identical parts, and is connected and detached by the assembling button 2230 on the supporting base 3100. Specifically, each conduit 3110 is composed of two circular tubes 3220, and the two circular tubes 3220 are provided with through holes 3222. In some embodiments, the shape of the through hole 3222 may be circular, oval, square, or other irregular shapes and geometric character shapes. A dismounting device 3223 is arranged between the circular tubes 3220, and the dismounting device 3223 is provided with a limiting part 3221 corresponding to the through hole 3222, and the limiting part 3221 is fixed in the through hole 3222 to form a limiting structure, so that two circular tubes 3220 are fixedly connected to form a conduit 3110. And the supporting base 3100 is composed of two conduits 3110. There is a slot on the outer surface of the conduit 3110, and an assembling button 2230 is installed in the slot. The assembling button 2230 is used to control the limiting part 3221 to enter and exit the through hole 3222. By pressing the assembling button 2230, the conduit 3110 can be disassembled into two circular tubes 3220, so that the whole supporting base 3100 can be divided into two parts, and the detachable function of the instrument repair bracket 1000 can be realized.

The instrument repair bracket 1000 is made of a hard material and is not limited in this embodiment. In other embodiments (not shown in the figure), the material of the instrument repair bracket 1000 can be titanium alloy, aluminum alloy, magnesium alloy, composite material, steel, resin-based composite material and other known materials, as long as the instrument repair bracket 1000 has sufficient strength and rigidity.

As shown in FIG. 4, as a preferred embodiment of the present invention, in order to make the instrument repair bracket 1000 flexible and convenient to use, the application of the present invention also provides a method for using the instrument repair bracket 1000.

The instrument repair bracket 1000 is a unique device, which is designed to provide a stable and adjustable platform for the installation and maintenance of gun instrument. This bracket consists of two main parts: one is the supporting component 2000, and the other is the base component 3000.

The supporting component includes a supporting frame 2100 and a supporting base 2200. The supporting frame 2100 is provided with an adjusting device, which consists of a transverse adjusting mechanism 2110 and a longitudinal adjusting mechanism 2130, and the longitudinal adjusting mechanism 2130 is externally connected with an adjusting member 2210, which is located on the supporting base 2200. The adjusting device can be used to adjust the accommodating space of the storage slot 2140, which can change the width of the storage slot and the height of the storage slot 2140 relative to the ground. The bracket base 2200 is also provided with an adjusting plate. In this embodiment, the transverse adjusting mechanism 2110 is an adjustment knob, and the storage slot 2140 is controlled by rotating the knob. In other embodiments, the transverse adjusting mechanism 2110 can be controlled in other ways.

When it is necessary to repair the bracket 1000 with instruments, it is first necessary to measure and record the length and width of the instruments to be repaired in order to adjust the device to place the repair instruments at the repair place. Specifically, the adjusting plate 2220) is used to adjust the front-rear distance of the bracket base 2200, so as to facilitate the placement of gun instrument in the storage slot 2140. Then, through the transverse adjusting mechanism 2110, the gun instrument can be firmly fixed in the storage slot 2140 to ensure the stability of the gun instrument during maintenance and adjustment. In addition, the height of the supporting frame 2100 can be adjusted by the adjusting member 2210, so that users can adjust the position of gun instrument according to their own height and habits, thus improving work efficiency and comfort level.

One of the important features of this design is its adjustability. Through the transverse adjusting mechanism 2110, the accommodation space of the storage slot 2140 can be adjusted, so as to adjust the clamping force of gun instrument. This means that whether you need to repair a large rifle or a small pistol, this instrument repair bracket 1000 can meet the demand. In addition, the longitudinal height of the supporting component 2000 can be controlled by poking the adjusting member 2210. This means that the height of the supporting component 2000 can be easily adjusted whether it is dialed up or down. Wherein, pulling the adjusting member 2210) upward moves the supporting component 2000 upward, and pulling the adjusting member 2210 downward moves the supporting component 2000 downward.

Another important feature is its flexibility. The adjusting plate 2220 is in contact with a conduit 3110 in the base component 3000 (as shown in FIG. 2). By snapping the adjusting plate 2220 away from the guide tube, the bracket base 2200 can slide above the supporting base 3100. This means that the bracket can be easily moved and repositioned during use or storage.

After adjusting the approximate repair height, a plurality of adjusters 3210 on the foot can be supported by knobs, and the adjusters 3210 can finely adjust the longitudinal height of the base component 3000. So that the instrument repair bracket 1000 can reach a most perfect repair state.

Finally, when it is no longer necessary to use this instrument to repair the bracket 1000, the supporting base 3100 can be disassembled and stored by assembling the button 2230. In this way, whether in use or in storage, the work area can be kept clean and orderly. Moreover, the detachable advantage can make the instrument repair bracket 1000 more convenient during transportation.

In a broad aspect of the present invention, the instrument repair bracket 1000 can be used not only for gun instrument, but also in other fields, such as photography. This bracket can be used as a bracket for cameras or lighting instrument, and photographers can adjust the height and angle of cameras as needed to obtain the best shooting effect. In addition, the position and angle of the lighting instrument can be adjusted according to the ambient light through the adjusting member and the handle; or in the electronic field, it can be used as a bracket for a tablet computer or a mobile phone, and users can adjust the angle of the device according to their own comfort, so that the best viewing experience can be obtained whether in bed, sofa or desk; or the field of tool supports, which can be used to fix various tools on a workbench or workstation, such as electric drills, grinders and other tools can be stably fixed on the supports, so that workers can operate more conveniently; or in the field of music, it can be used as a bracket for microphones or musical instruments. Musicians can adjust the height and angle of microphones or musical instruments according to their own needs, so that they can move and play more freely; or in the medical field, in hospitals or clinics, the bracket can be used to fix various medical instrument, such as infusion bottles, monitors and other instrument can be stably fixed on the bracket, so that medical staff can operate more conveniently.

To sum up, the brand-new instrument repair bracket 1000 provided by the application of the present invention can be adapted to different gun instrument by adjusting the vertical height and the front-rear distance. Moreover, the bracket has the advantages of adjustability, stability and flexibility, and is convenient for storage and transportation. It combines stability, adjustability and flexibility, and is suitable for the maintenance of different firearms, such as rifles, pistols and crossbows, and can be used for the installation and maintenance of firearms more conveniently and efficiently.

The terms “comprising.” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Similarly, the use of “based at least in part on” is meant to be open and inclusive, in that a process, step, calculation, or other action “based at least in part on” one or more recited conditions or values may, in practice, be based on additional conditions or values beyond those recited. Headings, lists, and numbering included herein are for ease of explanation only and are not meant to be limiting.

The various features and processes described above may be used independently of one another, or may be combined in various ways. All possible combinations and sub-combinations are intended to fall within the scope of the present disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed examples. Similarly, the example systems and components described herein may be configured differently than described. For example, elements may be added to, removed from, or rearranged compared to the disclosed examples.

The invention has now been described in detail for the purposes of clarity and understanding. However, those skilled in the art will appreciate that certain changes and modifications may be practiced within the scope of the appended claims. Conditional language used herein, such as, among others, “can,” “could,” “might,” “may,” “e.g.,” and the like, unless specifically stated otherwise, or otherwise understood within the context as used, is generally intended to convey that certain examples include, while other examples do not include, certain features, elements, and/or steps. Thus, such conditional language is not generally intended to imply that features, elements and/or steps are in any way required for one or more examples or that one or more examples necessarily include logic for deciding, with or without author input or prompting, whether these features, elements and/or steps are included or are to be performed in any particular example.

What is claimed is:

1. An instrument repair bracket with convenient adjustment, the bracket comprising:
at least one supporting component and a base component; and
wherein said at least one supporting component comprises a bracket base and a supporting frame detachably attached to said bracket base, wherein said supporting frame comprises at least one clamping piece, and said clamping piece is connected with a transverse adjusting mechanism in a transmission way, and said clamping piece defines a storage slot with an adjustable transverse width through the transverse adjusting mechanism, wherein said supporting frame is also provided with a longitudinal adjusting mechanism, and said longitudinal adjusting mechanism supports said storage slot, so that said storage slot has an altitude high position and an altitude low position; and
wherein said base component is provided with a track device and said at least one supporting component is provided with a notch complementary to the track device; and said at least one supporting component is slidably arranged above said base component through said track device and said slot device;
an adjusting plate is arranged in the notch, said track device is composed of a conduit, and said conduit is formed by detachable connection of at least two circular tubes, and a dismounting device is arranged between the at least two circular tubes, and said base component is integrated through detachable connection of said conduit;
one side of the adjusting plate is in close contact with the inner side wall of the bracket base, and the other side is connected with an elastic component and
an adjusting member is connected outside said longitudinal adjusting mechanism and said adjusting member is in said bracket base and used for controlling said supporting frame to move in a vertical direction;
the adjusting member needs to be pulled out first based on the supporting frame needs to be adjusted and lowered, and then the supporting frame needs to be adjusted so that the supporting frame can be lowered.

2. (canceled)

3. (canceled)

4. (canceled)

5. The instrument repair bracket with convenient adjustment according to claim 4, wherein at least one through hole is arranged in said circular tube of the at least two circular tubes, a limiting part is arranged on the dismounting device, said limiting part is fixed in said at least one through hole to form a limiting structure, and an assembling button is arranged at a joint between said circular tubes, and the assembling button can control the limiting part to enter and exit said through hole, so that a supporting base is connected and dismounted.

6. An instrument repair bracket with convenient adjustment, the bracket comprising:
at least two supporting components and a base component; and
wherein each supporting component of said at least two supporting components comprises a bracket base and a supporting frame detachably attached to said bracket base, wherein said supporting frame comprises at least one clamping piece, and said clamping piece is connected with a transverse adjusting mechanism in a transmission way, and said clamping piece defines a notch with an adjustable transverse width through said transverse adjusting mechanism, wherein said supporting frame is also provided with a longitudinal adjusting mechanism, and said longitudinal adjusting mechanism supports said storage slot, so that said storage slot has an altitude high position and an altitude low position; and
wherein, said base component is provided with a track device, and said each supporting component of the at least two supporting components is provided with a slot device complementary to said track device, and said each supporting component of said at least two supporting components is slidably arranged above said base component through said track device and said slot device; and
wherein, when said at least two supporting components slide above said base component, there is an adjustable distance between said two supporting components;
an adjusting plate is arranged in the notch, said track device is composed of a conduit, and said conduit is formed by detachable connection of at least two circular tubes, and a dismounting device is arranged between the at least two circular tubes, and said base component is integrated through detachable connection of said conduit;
one side of the adjusting plate is in close contact with the inner side wall of the bracket base, and the other side is connected with an elastic component and
an adjusting member is connected outside said longitudinal adjusting mechanism and said adjusting member is in said bracket base and used for controlling said supporting frame to move in a vertical direction;
the adjusting member needs to be pulled out first based on the supporting frame needs to be adjusted and lowered, and then the supporting frame needs to be adjusted so that the supporting frame can be lowered.

7. The instrument repair bracket with convenient adjustment according to claim 6, wherein an inside of said bracket base is a hollow structure, said supporting frame is received by said hollow structure of said bracket base, and said supporting frame is fixed inside said bracket base through said longitudinal adjusting mechanism.

8. The instrument repair bracket with convenient adjustment according to claim 7, wherein said bracket base is detachably connected with said supporting frame by inserting, at least a part of said supporting frame extends longitudinally beyond at least a part of a supporting base and said transverse adjusting mechanism controls a transverse distance of said storage slot by means of a knob.

9. The instrument repair bracket with convenient adjustment according to claim 8, wherein said base component is composed of the supporting base and a plurality of supporting legs and said supporting base is composed of at least two conduits, both ends of which are provided with outwardly bent extension parts, and the extension parts of said conduits are engaged with said plurality of supporting legs through fasteners.

10. The instrument repair bracket with convenient adjustment according to claim 9, wherein said conduit is formed by detachable connection of at least two circular tubes, and a dismounting device is arranged between said at least two circular tubes, and said base component is integrated through detachable connection of said conduit.

11. The instrument repair bracket with convenient adjustment according to claim 10, wherein said at least two circular tubes are provided with at least one through hole, and said dismounting device is provided with a limiting part and said limiting part is fixed in said through hole to form a limiting structure, so that at least two of said circular tubes form said conduit.

12. The instrument repair bracket with convenient adjustment according to claim 11, wherein an outer surface of said conduit is provided with a slot, and at least one assembling button is arranged in said slot, and the assembling button can control said limiting part to enter and exit said at least one through hole, so that said supporting base is connected and detached.

13. The instrument repair bracket with convenient adjustment according to claim 12, wherein said supporting base is detachably connected with a shelf, and said shelf is movably positioned above said supporting base through a snap connection, and said shelf is used for placing disassembled parts of gun instruments.

14. The instrument repair bracket with convenient adjustment according to claim 13, wherein a straightening piece is arranged in a middle of said supporting base, and said straightening piece is used for keeping said at least two conduits parallel, and said straightening piece is detachably connected with said supporting base through fasteners.

15. The instrument repair bracket with convenient adjustment according to claim 14, wherein an adjusting plate is arranged in a notch, and said adjusting plate is suspended in said supporting base and is configured to contact with at least one of an inner side wall of said supporting base and said conduit respectively.

16. The instrument repair bracket with convenient adjustment according to claim 15, wherein said adjusting plate is equipped with at least two elastic component placed between said supporting base and said adjusting plate, so that said adjusting plate is closely attached to said supporting base.

17. The instrument repair bracket with convenient adjustment according to claim 16, wherein each supporting leg of said plurality of supporting legs is equipped with a plurality of adjusters, and said plurality of adjusters are fixed on said supporting leg through threaded connection and are configured to adjust a vertical height of said instrument repair bracket.

18. A use method of an instrument repair bracket with convenient adjustment, the method comprising:
providing an instrument repair bracket; and
wherein, said instrument repair bracket comprises at least two supporting components and a base component slidably arranged below said supporting components, wherein said supporting component comprises a supporting frame and a bracket base, wherein a middle part of said supporting frame is provided with a storage slot, and said supporting frame is provided with an adjusting device, and said adjusting device can adjust an accommodating width of said storage slot and a height of said storage slot relative to a ground; and
said use method comprises the following steps:
respectively adjusting said accommodating width of said storage slot; and
respectively adjusting the height of said storage slot relative to the ground; and
adjusting a relative distance between at least two supporting components.

19. The use method of an instrument repair bracket with convenient adjustment according to claim 18, wherein a transverse width of an instrument to be repaired is measured and recorded before the accommodating width of said storage slot is adjusted respectively, and the accommodating width of said instrument to be repaired is adjusted according to a measurement data.

20. The use method of an instrument repair bracket with convenient adjustment according to claim 18, wherein before adjusting the relative distance between at least two supporting components, a length of said instrument to be repaired is measured and recorded, and the relative distance between at least two supporting components is adjusted according to a measurement data, so that the relative distance is suitable for repair operation.
